(19) United States
(12) Patent Application Publication
(10) Pub. No.: US 2013/0221590 A1
(43) Pub. Date: Aug. 29, 2013

(54) ALIGNMENT TOOL

(71) Applicant: Geert Kerckhofs, Dilbeek (BE)

(72) Inventor: Geert Kerckhofs, Dilbeek (BE)

(73) Assignee: CARBORAM, NAAMLOZE VENNOOTSCHAP, Merchtem (BE)

(21) Appl. No.: 13/823,544

(22) PCT Filed: Nov. 15, 2011
(86) PCT No.: PCT/BE11/00066

§ 371 Date: Apr. 30, 2013

(30) Foreign Application Priority Data
Nov. 15, 2010 (BE) 2010/0676

(51) Int. Cl. B25B 5/00; B25B 11/00

(52) U.S. Cl. CPC B25B 5/00; B25B 11/005
USPC 269/21; 269/41

(57) ABSTRACT

Alignment tool for positioning two close-fitting pieces of material together at an angle with respect to one another, that is equipped with a supporting section with which the alignment tool can rest on a first piece of material, and a table on which the second piece of material can be affixed at the aforementioned angle with respect to the first piece of material, whereby moreover the table is affixed movably on the supporting section to make one or more translation movements with respect to the supporting section, whereby the alignment tool is equipped with releasable securing elements.

The present invention relates to an alignment tool.

More specifically the present invention relates to an alignment tool for positioning two close-fitting pieces of material together that have to be glued together at an angle with respect to one another.

Without limiting the invention to this, such an alignment tool according to the invention can typically be used to glue a skirt of natural stone to the edge of a tabletop or similar.

However, other materials such as glass, wood, metal, plastic and so on are not excluded from the invention.

According to the current state of the art, alignment tools are already known for such a purpose, for example in the form of one or more ‘cramps’ or G-clamps, whereby the two pieces of material can be held together and tightened against one another while being glued.

To set the angle at which the pieces of material have to be glued, one or more set squares (at least if the angle is) 90° or similar instruments are generally used.

A great disadvantage of these known alignment tools however is that they are very awkward to use, especially when the pieces of material to be glued are very long and very heavy, as is often the case with stone materials.

More specifically it is the case that the two pieces of material, before being glued in the correct position with respect to one another, have to be brought together in order to examine whether there is a good fit between the two pieces of material and whether or not additional grinding operations or similar are needed to obtain a good fit between the parts.

After any additional grinding operations, such a verification often has to be done again one or more times until it is established with certainty that the two pieces of material perfectly fit together for gluing, after which the pieces have to be moved apart to apply glue between the pieces for final gluing.

With the aforementioned known alignment tools, repeatedly bringing the two pieces of material together and moving them apart again is very laborious, whereby it is necessary to start from zero again each time.

Furthermore, it is also the case that with the known alignment tools, during the last step, in which glue has already been applied to the pieces of material, the two pieces of material can often not be brought together in one smooth movement.

As a result, glue often gets into the wrong places and/or as a result of smearing insufficient glue remains between the two pieces of material, as the pieces of material often have to be moved or turned to the right position after they have already been brought into contact with one another.

The purpose of the present invention is to provide a solution to the aforementioned and any other disadvantages.

To this end the present invention concerns an alignment tool for positioning two close-fitting pieces of material together that have to be glued together at an angle with respect to one another, whereby the alignment tool at least has a supporting section with which the alignment tool can rest on a first piece of material, and a table on which the second piece of material can be placed at the aforementioned angle with respect to the first piece of material, whereby moreover the table is affixed movably on the supporting section to make one or more translation movements with respect to the supporting section in order to be able to bring the two pieces of material together or to move them apart, without hereby undergoing a relative angular movement and whereby the supporting section is equipped with releasable securing means with which the table can be fastened in any position with respect to the supporting section.

A big advantage of such an alignment tool according to the invention consists of the table and the supporting section of the alignment tool always being at the desired angle with respect one another, irrespective of the position of the table on the supporting section, so that the two pieces of material that have to be glued can be moved to and from one another a number of times according to one and more translation movements, without undergoing a relative angular movement.

According to a preferred embodiment of an alignment tool according to the invention, the alignment tool has a support surface, against which the second piece of material affixed to the table can rest during a movement of the table, in order to set the aforementioned angle to the first piece of material on which the supporting section can rest, whereby the supporting section at least has a guide over which the table can undergo a translation movement in a direction parallel to the support surface against which the second piece of material can be placed against the table.

As will be demonstrated hereinafter, such an embodiment of an alignment tool according to invention is highly suitable for gluing two mitred pieces of material together for example, such as mitred pieces of stone.

According to a more preferred embodiment of an alignment tool according to the invention, the supporting section consists of two parts that can be moved with respect to one another, whereby the table is movable with respect to the first part, and the second part at least has a guide over which the first part with the table can undergo a translation movement in a direction that is not parallel to the aforementioned support surface for the second piece of material, and whereby additional releasable securing means are provided with which the first part of the supporting section can be fastened in the aforementioned guide in any position.

Such an embodiment of an alignment tool according to the invention is even more flexible because the table itself can undergo a translation movement with respect to the first part, for example parallel to the support surface for the second piece of material, while the table together with this first part can also undergo a translation movement with respect to the second part in a direction that is not parallel to this support surface.

In some situations the gluing of the two pieces of material cannot be done by just executing a translation movement of the table in a direction parallel to the support surface for the second piece of material, without necessarily spreading and/or smearing the applied glue.

This is the case for example when a non-mitred, and thus straight, skirt has to be glued perpendicular to a table edge.

In the event of a movement in the plane of the skirt perpendicular to the table edge, glue applied to the skirt will inevitably be smeared on the table edge, which is clearly not the intention.

With an alignment tool according to the invention, in this last preferred embodiment the table has an additional movement possibility in a direction that is not parallel to the support surface for the second piece of material, such that the spreading and smearing of glue can be avoided in such cases, while the two pieces of material can nevertheless be brought together in one smooth movement while gluing, and whereby during the movement of the pieces of material with the table to and from one another, the pieces of material are always kept at the same angle with respect one another.

In a preferred embodiment of an alignment tool according to the invention, it is provided with a limiting means to limit and guide the movement of the table to the first piece of material.

A great advantage of such an alignment tool according to the invention is that, as a result of the limiting means, the table can be moved with certainty in a smooth movement whereby the pieces of material can be positioned with a close fit to one another in one go, and thus the spreading and smearing of glue is avoided during the final gluing.

With the intention of better showing the characteristics of the invention, a few preferred embodiments of an alignment tool according to the invention are described hereinafter by way of an example, without any limiting nature, with reference to the accompanying drawings, wherein:

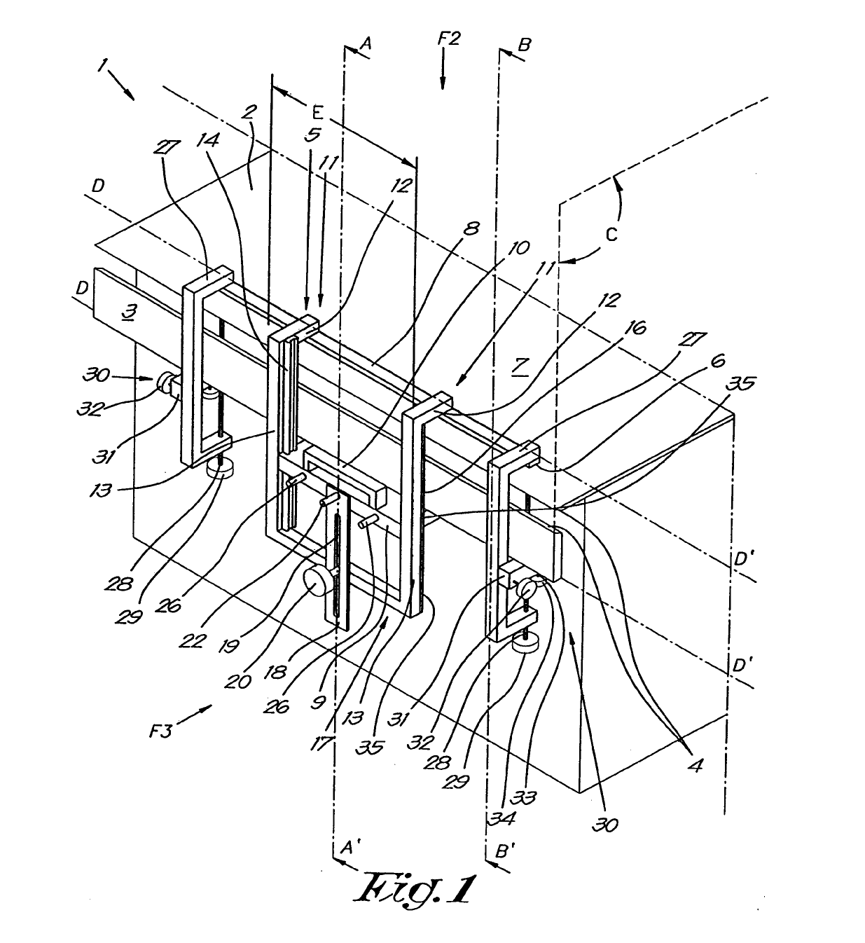

FIG. 1 shows an alignment tool according to the invention in perspective during use for gluing a mitred skirt to an edge of a tabletop;

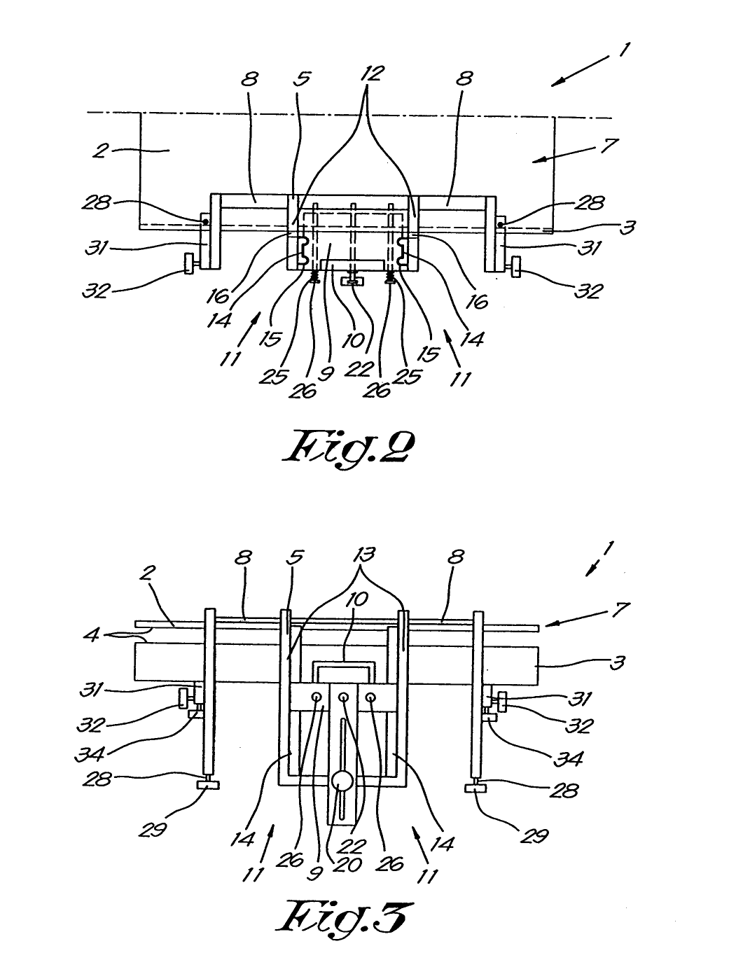

FIGS. 2 and 3 respectively show a top view and a front view of the situation of FIG. 1, indicated respectively by arrows F2 and F3 in FIG. 1;

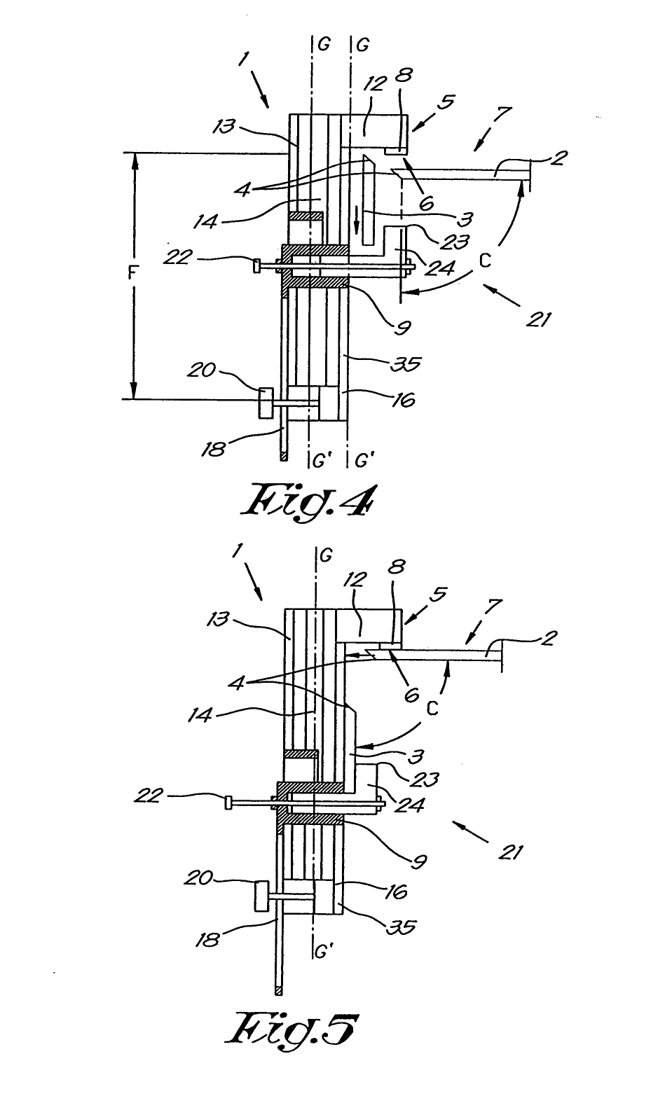

FIGS. 4 to 7 show views according to a cross-section indicated by AA′ in FIG. 1, in successive positions of the alignment tool when gluing the skirt to the tabletop;

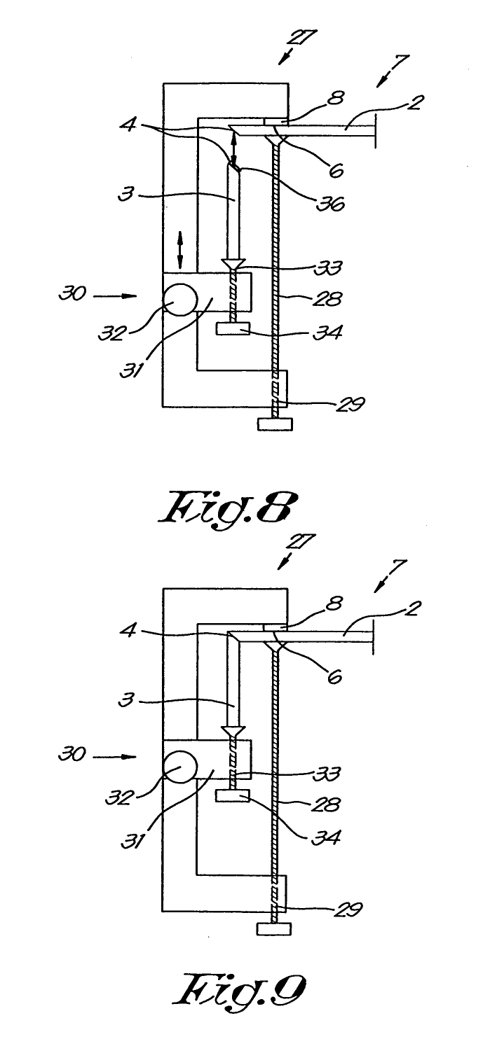

FIGS. 8 and 9 show views of tightening means of the alignment tool according to a cross-section indicated by BB′ in FIG. 1, respectively in a position before and after the skirt and the tabletop have been brought together;

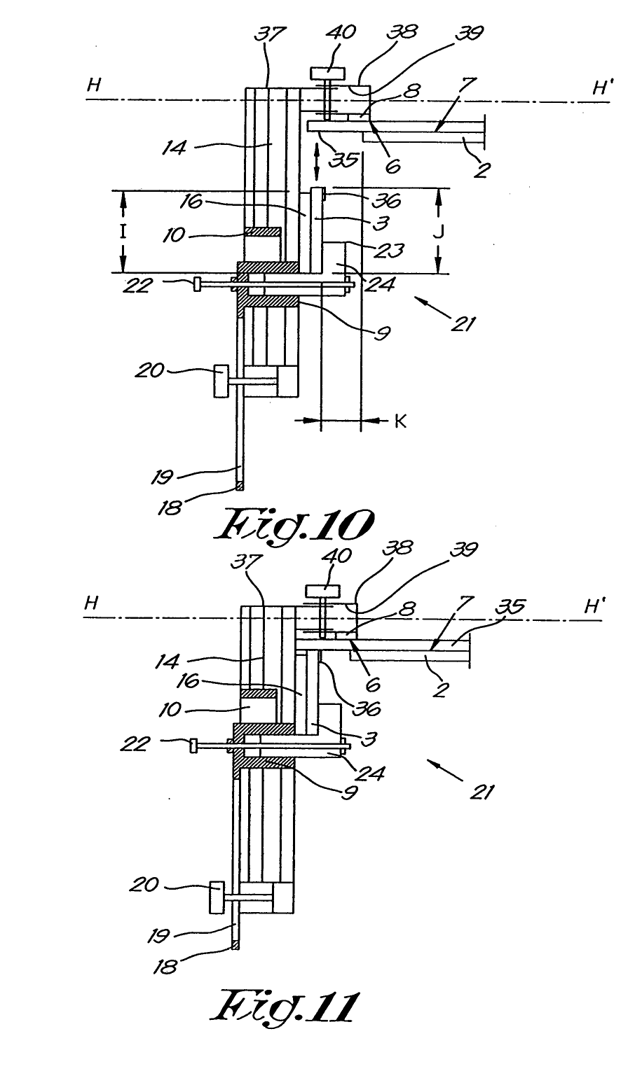

FIGS. 10 to 11 show cross-sections, similar to the cross-sections of FIGS. 5 to 7 in successive positions, of an alternative embodiment of an alignment tool according to the invention, which is suitable for gluing a non-mitred skirt to the front of an edge of a tabletop;

FIG. 13 shows another possible embodiment of an alignment tool according to the invention according to a cross-section similar to FIG. 5;

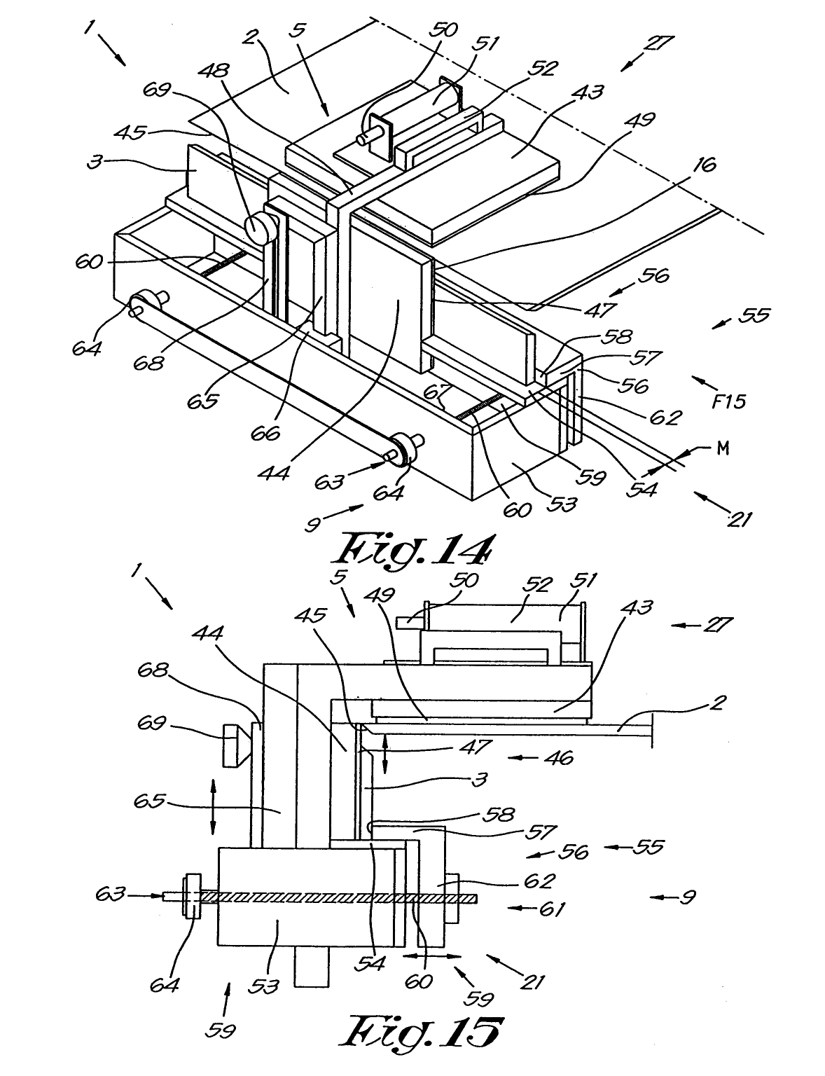

FIG. 14 schematically shows in perspective another possible embodiment of an alignment tool according to the invention;

FIG. 15 schematically shows a side view according to arrow F15 of the embodiment of FIG. 14;

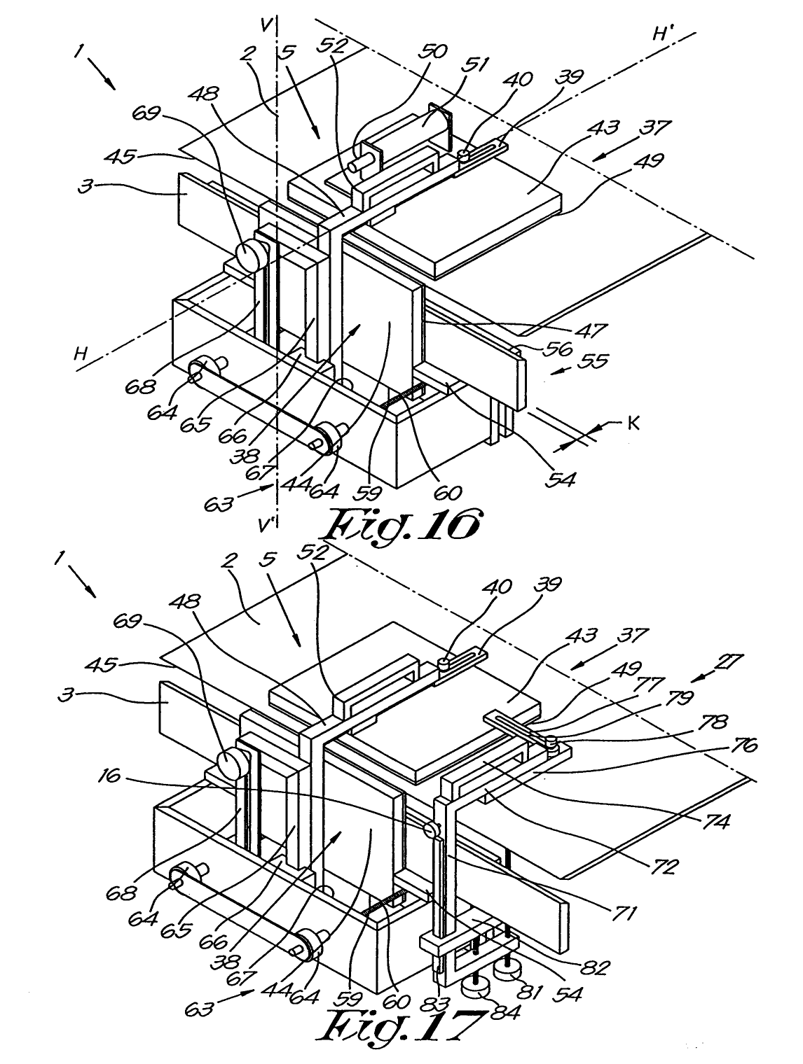

FIGS. 16 and 17 show, similar to FIG. 14, other possible embodiments of an alignment tool according to the invention;

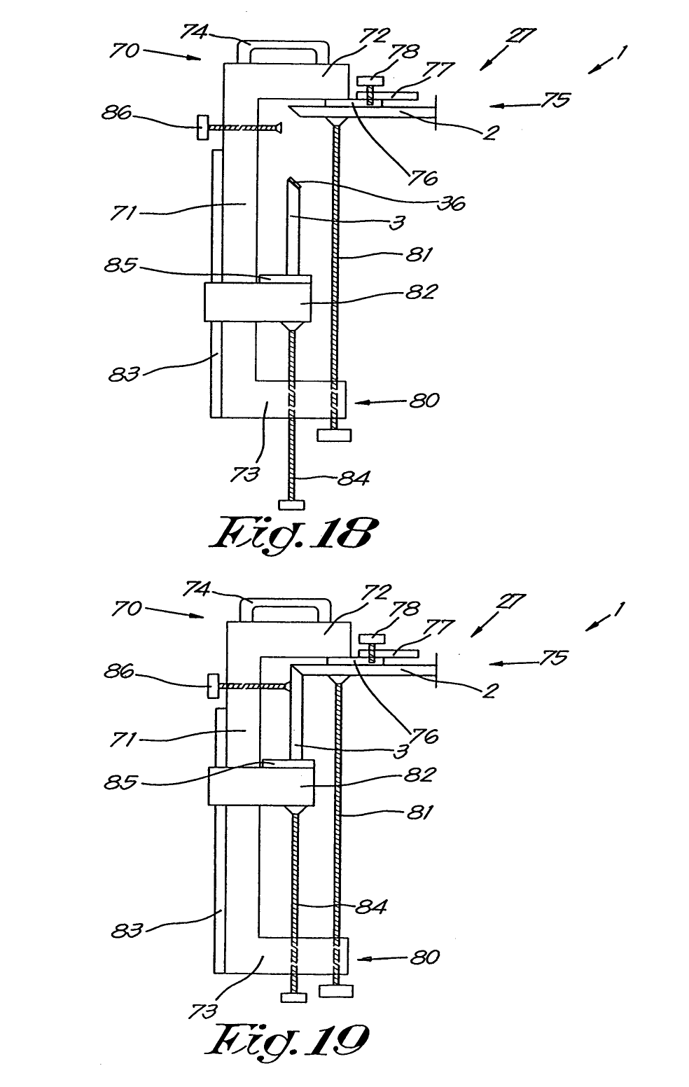

FIGS. 18 and 19 show a side view of a simplified form of an alignment tool according to the invention constructed as a tightening means, respectively in a removed position of the first and second piece of material to be glued and in an assembled position of these pieces of material.

The alignment tool 1 according to the invention illustrated in FIGS. 1 to 9 is intended for positioning two close-fitting pieces of material 2 and 3 together, in this case respectively a first piece of stone 2 in the form of a tabletop 2 and a second piece of stone 3 in the form of a skirt 3 that has to be glued to the edge of the tabletop 2.

More specifically in this case it is the intention to glue the skirt 3 at an angle C of 90° to the tabletop, but alignment tools 1 in which other angles C are used between the two pieces of stone 2 and 3 during gluing are not excluded according to the invention.

In the example shown, the skirt 3 and the tabletop 2 are to be glued at an angle of 90°, and both pieces of stone 2 and 3 each have a mitred edge 4 with an angle of 45° for the aforementioned purpose.

However, the alignment tool 1 according to the invention can equally be applied or adapted to applications where the angle C is not 90°, or whereby the pieces of stone 2 and 3 are not mitred or present a mitre of a different angle.

The pieces of stone 2 and 3 can be manufactured from a natural stone, for example, such as marble or similar, but other natural stone types as well as synthetically manufactured stone types are not excluded according to the invention.

Moreover, the invention does not exclude the use of the alignment tool 1 to glue other types of materials such as wood, metal, glass, plastic and so on.

The alignment tool 1 according to the invention has a supporting section 5 whereby the alignment tool 1 can rest on a first piece of material, in this case the tabletop 2.

This supporting section 5 according to the invention preferably has one or more zones, which together form a support surface 6 in order to be able to rest against a flat side 7 of a piece of material 2.

In the example shown, to this end the supporting section 5 has one such zone consisting of one side of a beam-shaped profile 8 to form an aforementioned support surface 6, but a supporting section 5 with completely different forms is certainly not excluded according to the invention.

Another essential aspect of an alignment tool 1 according to the invention is the fact that the alignment tool 1 is also equipped with a table 9 on which the second piece of stone 3, in this case formed by the skirt 3, can be affixed at the aforementioned angle C with respect to the first piece of stone 2, in this case formed by the tabletop 2.

Furthermore the table 9 according to the invention is movably affixed to the supporting section 5 and such that the table 9 can make one or more translation movements, and more precisely only one or more translation movements and no rotation movements, with respect to the supporting section 5.

Indeed it is the intention to be able to bring the two pieces of stone 2 and 3 together or move them apart without changing the angle C between the skirt 3 and the tabletop 2.

For easy handling of the table 9, a handle 10 can be provided on the table 9.

In the embodiment shown in FIGS. 1 to 7, the alignment tool 1, and more specifically the supporting section 5 of the alignment tool 1, has two parallel hooks 11 that each consist of two arms 12 and 13 perpendicular to one another.

Hereby the hooks 11 are linked together by means of the transversely oriented beam-shaped element 8 that acts as a support surface 6 with which the supporting section 5 rests on the tabletop 2, whereby the beam-shaped element 8 is connected to a first arm 12 of each hook 11.

On the other arm 13 of each hook 11, in the example shown there is a rail 14 each time, and these rails 14 together form a guide for moving the table 9 over these rails 14.

To this end, in this case the table 9 has a groove 15 on either side that is complementary to the rail 14 concerned.

Of course many other possibilities for the movable arrangement of a table 9 on the supporting section 5 are not excluded according to the invention.

For example, small wheels or roller elements or similar can be used to this end

In the example shown the alignment tool 1 has a support surface 16 against which the second piece of stone 3 that is affixed on the table 9 can rest during the movement of the table 9, whereby the support surface 16 in fact sets the aforementioned angle C with the first piece of stone 2 on which the supporting section 5 rests, as well as the longitudinal direction DD′ along which the piece of stone 3 extends.

In this case this support surface 16 rather forms part of the supporting section 5 and is formed by two flat strips that are made from teflon or nylon or similar, for example, over which the skirt 3 can slide during a movement of the table 9.

The support surface 16 formed by the strips 16, made from teflon, nylon or similar, hereby extends over the sides of the second arms 12 that are oriented towards the first arms 12 of the hooks 11 that form the supporting section 5.

However the invention does not exclude the table 9 being constructed such that the support surface 16 also forms part of the table 9 itself.

In order to sufficiently accurately set the position, more specifically the angle C between the two pieces of stone 2 and 3 and the direction DD′ along which the pieces of stone 2 and 3 extend, it is advantageous to have support points on the support surface 16 that are located proportionally far from one another, and this in two directions.

This can be done for example by making the distance E between the two hooks 11 sufficiently large and making the strips 16 with a sufficiently large length F.

In this way the second piece of stone 3 that is affixed against the support surface 16 is automatically well aligned without large errors being able to occur.

In the embodiment shown in FIGS. 1 to 7 the guides 14 extend in a direction GG′ in the longitudinal direction GG′ of the second arms 13 of the hooks 11, or in other words parallel to the aforementioned support surface 16 formed by the strips 16 against which the skirt 3 can rest during a movement of the table 9, such that the table 9 can undergo a translation movement in this direction GG′ parallel to the support surface 16.

Thus the rails 14 form a perpendicular guide for the table 9 and this guide is perpendicular on the aforementioned support surface 6 formed by the supporting section 5 for the first piece of stone 2.

Furthermore an alignment tool 1 according to the invention has a releasable securing means 17 with which the table 9 can be fastened in any position with respect to the supporting section 5.

In the examples shown this is simply realised by means of a small plate 18 with groove 19, and this plate is fastened to the table 9 and whereby during the translation movement of the table 9 the small plate 18 slides with its groove 19 around a screw 20 that is affixed in the supporting section 5.

By unscrewing the screw 20, the table 9 together with the small plate 18 can freely move, whereby the groove 19 acts as a type of guide for the translation movement of the table 9 over the rails 14, after which by simply retightening the screw 20 in the supporting section, the table 9 can be fastened in the desired position.

In order to be able to easily hold the second piece of stone 3 on the table 9 and to secure the table in the guide 14, the table 9 preferably, as shown in the examples, is equipped with additional releasable securing means 21.

In this case these additional securing means 21 are formed among others by a seat 23 controlled with a pusher peg 22 that is movably mounted with respect to the table 9, and which has a back 24 parallel to the aforementioned support surface 16 for the second piece of stone 3.

As a result the seat 23 can move in a direction transverse to the support surface 16.

Moreover, there are also spring elements 25 that exert a force on the seat 23 in a direction towards the aforementioned support surface 16 in order to be able to hold the second piece of stone 3 between the back 24 and the support surface 16.

In this case the spring elements 25 are coiled springs 25 that are around bolts 26 that form a guide for the seat 23.

The pusher peg 22 is preferably constructed as a bolt with screw thread that is securely fastened to the seat 23 and thus moves with the seat 23, whereby there is also a nut on the screw thread of the pusher peg 22 to clamp the seat with respect to the table 9.

Of course many other embodiments with completely different securing means 17 and/or 21 are not excluded from the invention.

Preferably the supporting section 5 of an alignment tool 1 according to the invention has tightening means 27 integrated in the alignment tool 1 for fastening the supporting section 5 to the first piece of stone 2 to be glued.

Such tightening means 27 are shown in more detail in FIGS. 1, 8 and 9 and in this example they are formed by a pair of cramps 27 that are fastened to the beam-shaped profile 8 on either side of the hooks 11.

Hereby each cramp 27 has a fast-action bolt 28 operated via a screw 29 and whereby the supporting section 5 can be clamped against the first piece of stone 2 between the bolt 28 and the profile 8.

In another embodiment of an alignment tool 1 according to the invention, the tightening means 27 can for example be formed by means with which a vacuum can be created to fasten the alignment tool 1, for example tightening means 27 in the form of suction pads or similar.

According to another preferred embodiment of an alignment tool 1 according to the invention, the supporting section 5 has additional tightening means 30 integrated in the alignment tool 1 to tighten the second piece of stone 3 to be glued against the first piece of stone 2 to be glued.

These additional tightening means 30 are formed in the example shown by an arm 31 that can be moved in the translation direction GG′ of the table 9 over the rails 14 on the cramps 27.

To this end the arm 31 has a screw 32 with which the arm 31 can easily be brought close to the table 9.

Moreover, in the arm 31 there is a fast-action bolt 33 that is operated via a screw 34 with which the second piece of stone 3 can be clamped against the first piece of stone 2.

Preferably the additional tightening means 30 are such that an adjustment can be achieved in three directions.

In an alternative embodiment it can be chosen not to integrate the tightening means 27 and 30 in the alignment tool. In order to clamp the alignment tool 1 to the first piece of stone 2, use is made of separate cramps 27 or similar and/or separate similar tightening means to adjust and tighten the second piece of stone 3 against the first piece of stone 2.

Another preferred characteristic of an alignment tool 1 according to the invention consists of providing the alignment tool 1 with limiting means 35 in order to limit and guide the movement of the table 9 up to the first piece of stone 2.

As will be demonstrated further, in this case the aforementioned limiting means 35 are formed by the flat strips 16 on the supporting section 5, that also form a support surface 16 over which the second piece of stone 3 can slide during a movement of the table 9.

The operation and use of an alignment tool 1 according to the invention is simple and will be explained hereinafter on the basis of FIGS. 1 to 9.

A first step consists of correctly supporting the alignment tool on the first piece of stone 2.

To this end the beam-shaped profile 8 of the alignment tool 1 must be placed on the flat side 7 of the first piece of stone 2.

As shown in FIG. 4, the skirt 3 can affixed to the table.

As a result of the compression of the spring elements 25, for example with the help of a pusher peg 22, the seat 18 is moved in a direction away from the support surface 16, such that sufficient space arises between the support surface 16 and the back 24 for placing the second piece of stone 3 or skirt 3.

After releasing the spring elements 25, the position shown in FIG. 5 is obtained whereby the skirt 3 is held between the support surface 16 and the back 24 of the seat 23.

By screwing in the nut provided on the pusher peg 22, the skirt 3 can be additionally securely clamped to the table 9.

Afterwards the alignment tool 1 can be correctly positioned with respect to the first piece of stone 2.

Hereby the entire alignment tool 1 is moved over the first piece of stone 2 until the edge 4 of this piece of stone 2 rests against the limiting means 35 formed by the teflon or nylon strips 16.

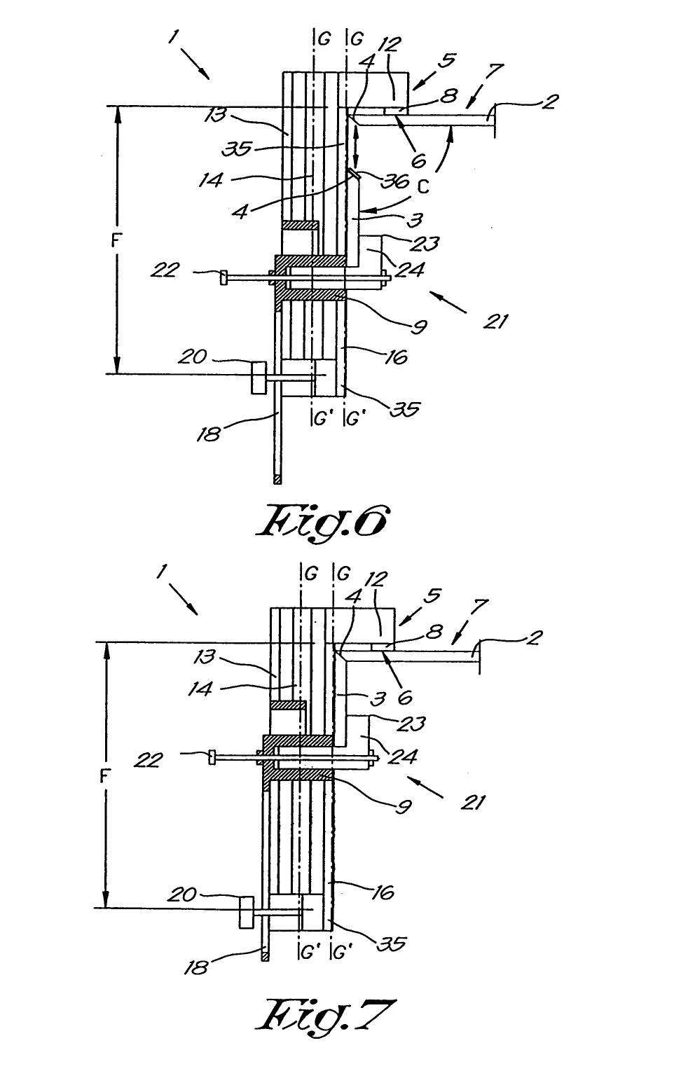

This position shown in FIG. 6.

After correctly placing the alignment tool 1 on the first piece of stone 2, it is the intention to fix this position by clamping the supporting section 5 to the first piece of stone 2 by means of the tightening means 27, more specifically with the fast-action bolts 28 and screws 29.

As stated, to this end other techniques such as vacuum techniques and similar can be used.

It is clear that after all these operations a situation is obtained whereby a second piece of stone 3 in the form of a skirt 3 is affixed to a table 9 that can make a translation movement along the support surface 16 between a position in which the second piece of stone 3 is removed from the first piece of stone 2 and a position in which the second piece of stone 3 is guided up to the first piece 2 via the limiting means 35, which in this case are also formed by the support surface 16.

Furthermore, it must be noted here that the form of the alignment tool automatically maintains the correct angle C, which in this case is 90°.

Thus the second piece of stone 3 can be moved up to the first piece of stone 2 in one smooth movement, via a movement of the table 9 over the rails 14, for example to check whether a there is good fit between the two stones 2 and 3.

After any adjustment of the pieces of stone 2 and 3, glue 36 can finally be applied to the edges 4 of the pieces of stone 2 and 3, after which the gluing can be completed very efficiently.

Such a position is shown in FIG. 7, for example.

Finally the pieces of stone 2 and 3, after having been brought against one another using the table 9, can be additionally tightened against one another with the tightening means 30, in order to exert the required force on the pieces to obtain good gluing, which is shown more clearly in FIG. 9.

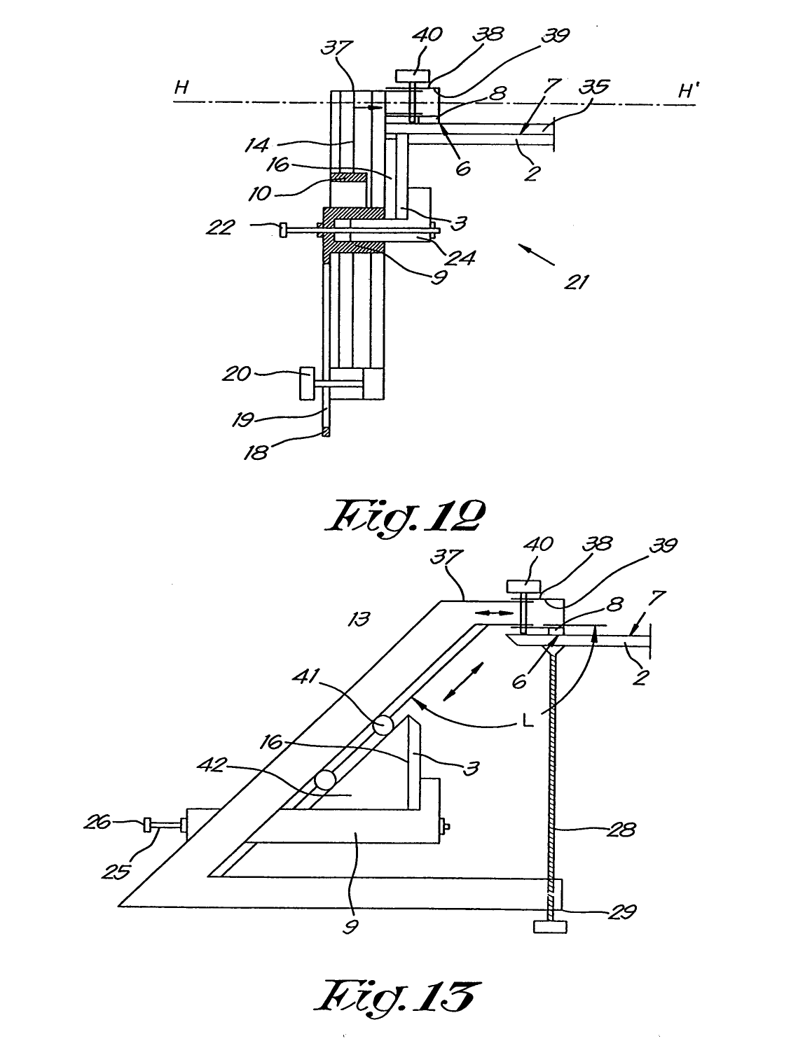

FIGS. 10 to 12 show another embodiment of an alignment tool 1 according to the invention, whereby in this case the supporting section 5 consists of two parts 37 and 38 that can be moved with respect to one another.

Hereby the table 9 is movable with respect to the first part 37, and the second part 38 has an additional guide 39 over which the first part 37 with the table 9 can undergo a translation movement in a direction HH′ that is not parallel to the aforementioned support surface 16 for the second piece of stone 3.

The direction HH′ in the example shown is perpendicular to the aforementioned support surface 16, but this does not need to be the case.

Furthermore, additional releasable securing means 40 are also provided with which the first part 37 of the supporting section can be fastened in the additional guide 39 in any position.

In this case all this is realised by the making the arms 12 of the hooks 11 telescopic, whereby the first part 37 of these arms 12 is guided over the inside 39 of the second part 38 of these arms 12, whereby the two parts 37 and 38 can be fastened with respect one another by means of a bolt 40.

In another embodiment, the two parts 37 and 38 can be connected via a precision guide or rail system or similar.

In this way the alignment tool 1 is equipped with a second guide 39 for the table 9, and in this case this guide 39 is parallel to the aforementioned support surface 6 formed on the supporting section 5 for the first piece of stone 2.

Of course, all kinds of other possible embodiments according to the invention are not excluded.

In this embodiment, the support surface 16 to support the second piece of stone 3 on the table 9 during a movement of the table 9 forms part of the table 9, and is constructed with a height I that is less than the height J of the piece of stone 3.

Moreover there are limiting means 35, which this time are formed by a plate 35 that is affixed under the beam-shaped profile 8 and which extends over the flat side 7 of the first piece of stone 2.

Furthermore, the structure of an alignment tool according to this embodiment is completely similar to the previous embodiment.

As will be illustrated on the basis of FIGS. 10 to 12, this embodiment provides an additional translation possibility for the table 9 in the direction HH′, whereby such an alignment tool 1 is suitable, for example, for gluing a straight skirt 3 for a straight finished edge 4 of a tabletop 2.

After all it is sufficient to place the skirt 3 on which glue 36 has been applied on the table 9, whereby in the first instance a sufficiently large distance K in the direction HH′ is left between the second piece of stone 3 and the first piece of stone 2.

This position is shown in FIG. 10.

The table 9 is then brought up against the limiting means in the form of the plate 35, in other words up to a position as shown in FIG. 11, whereby the top of the skirt 3 is aligned with the flat side 7 of the tabletop 2.

Finally, through a translation movement of the table 9 along the direction HH′ over the distance K, and this movement is possible as a result of the telescopic construction of the arms 12 of the hooks 11, the pieces of stone 2 and 3 are brought against one another for gluing, and this again without spreading or smearing the glue 36.

For a good tightening of the second piece of stone 3 to the first piece of stone 2, an additional adjustment of the tightening means 30 is required, which can be done in an obvious way.

In order to emphasise that the invention is not limited to the versions described so far, FIG. 13 shows another embodiment of an alignment tool 1 according to the invention that has a somewhat exotic form.

Here the supporting section is formed by arms 12 and 13 that are not perpendicular to one another, but at an angle L.

The table 9 can be movably affixed over this supporting section 5 using wheels 41.

Moreover the skirt 3 is held on the table 9 in a position at 90° with respect to the tabletop 2 by means of a wedge-shaped support 42 with support surface 16.

The arms 13 of the supporting section 5 hereby form, as in the embodiment of FIGS. 1 to 9, limiting means 35 for correctly placing the alignment tool 1.

It is clear that with this embodiment, the table 9 with skirt 3 can also be moved in one smooth movement against the tabletop 2, whereby this time however a translation movement is executed that is oblique with respect to the support surface 16, as well as with respect to the flat side 7 of the tabletop 2.

Hereby it is clear that there are many possibilities for constructing an alignment tool 1 according to the invention.

In another embodiment, for example, it is not excluded that the hooks 11 are constructed with arms 12 and 13 between which the angle L is adjustable, or with a wedge-shaped support 42 whose wedge can be adjusted according to desire.

In the examples described so far, the alignment tool 1 according to the invention is a manual tool that is always intended to be set up completely manually.

However, it is not excluded according to the invention that certain components of the alignment tool are equipped with automated devices, such as electrically, hydraulically or pneumatically driven devices.

It could for example be chosen to use such automated devices to secure and release the supporting section 5 of the alignment tool 1, or to control the table 9 or even to fasten a piece of material to the table 9 itself.

FIGS. 14 and 15 show another embodiment of an alignment tool 1 according to the invention, whereby again two pieces of material, i.e. a first piece of material 2 in the form of a tabletop 2 and a second piece of material 3 in the form of a skirt 3, have to be glued together at an angle C with respect to one another, and this angle C in this case is again 90°.

In this embodiment the alignment tool 1, just as in the previous embodiments, is also provided with a supporting section 5 with which the alignment tool 1 can rest on the tabletop 2, as well as a table 9, on which the second piece of material 3, in this case a skirt 3, can be affixed at the aforementioned angle C with respect to the first piece of material 2, more specifically the tabletop 2, but the supporting section 5 and the table 9 are constructed somewhat differently than in the previous embodiments.

More specifically, in this case the supporting section 5 contains a first flat plate 43 that is actually intended to support the tabletop 2, as well as a second flat plate 44 that is placed perpendicularly to the first flat plate 44, and this second flat plate 44 acts as a support surface 16 against which the skirt 3 can rest during the movement of the table 9, and which on the other hand can be used to align the alignment tool 1 with an edge 45 of the tabletop 2.

Preferably the support surface 16 of the second flat plate 44 is formed by a material with low frictional resistance such as teflon, for example by applying teflon strips 47 on the side 46 of the second flat plate 44 that is oriented towards the skirt 3, or by manufacturing this side 46 of the second flat plate 44 entirely out of teflon 47 or similar.

The two flat plates 43 and 44 in this case are connected together by means of a perpendicular profile 48, but the plates 43 and 44 can just as well be connected directly together, for example by welding them together and similar.

Other ways for connecting the two flat plates 43 and 44 together are of course not excluded according to the invention.

A characteristic of the embodiment of FIGS. 14 and 15 is the fact that the first flat plate 43 is constructed as a suction pad 49 that is equipped with a vacuum pump 50.

It is of course the intention that the alignment tool 1 can be secured to the tabletop 2 with this suction pad 49 and vacuum pump 50, in order to securely position it on the tabletop 2, at least during the early phase of the gluing, more specifically the phase in which the skirt 3 has to be positioned against the tabletop 2.

The suction pad 49 preferably consists of a flexible material and in this case the vacuum pump 50 is integrated in a first handle 51 with which the alignment tool 1 can be grasped in order to position it on the tabletop 2.

In the embodiment shown in FIGS. 14 and 15, a second handle 52 is also provided above the perpendicular profile 48.

A great advantage of this embodiment of an alignment tool 1 according to the invention is that the supporting section 5 has tightening means 27 integrated in the alignment tool 1 in the form of a suction pad 49 and vacuum pump 50, in order to fasten the supporting section 5 to the tabletop 2, so that separate tightening means 27 are not necessarily needed, at least while positioning the skirt 3 with respect to the tabletop 2.

Another advantage of this embodiment of an alignment tool 1 according to the invention is that in this case the aforementioned tightening means 27 are formed by a suction pad 49 with a vacuum pump 50, so that the risk of damage to the tabletop 2 is practically non-existent, which is often a problem for tabletops 2 of polished natural stone, etc, with the usual tightening means 27 in the form of cramps 27 and similar.

By integrating the vacuum pump 50 in a handle 51, a very compact and easily useable form is also obtained.

In the embodiment shown, the table 9 is primarily formed by a rectangular frame 53 that is partially covered on top by a small plate 54, that is preferably manufactured from a material with a low frictional resistance such as teflon for example, and which encloses the second flat plate 44, more specifically on the side 55 of the frame that is oriented towards the skirt 3.

In this embodiment the small plate 54 first and foremost acts as a support of the skirt 3 and as a guide for the frame 53 around the second flat plate 44 of the supporting section 5, but of course the invention does not exclude the use of completely different means to support the skirt 3 or to guide the table 9.

The table 9 also has additional releasable securing means to fasten the skirt 3 to the table 9, and in this embodiment these additional releasable securing means 21 consist of an L-shaped profile 56, whereby one limb 57 of this L-shaped profile 56 is affixed movably over the small plate 54, in order to clamp the skirt 3 between an edge 58 on this limb 57 of the L-shaped profile 56 and the support surface 16 on the second flat plate 44 of the supporting section 5.

The distance M between the L-shaped profile 56 and the support surface 16 can be adjusted by means of a screw connection 59, consisting of two bolts 60 with external screw thread that are affixed through the frame 53, and which at one and 61 are fastened to the second limb 62 of the L-shaped profile 56, and which at the other end 63 has an adjustment screw 64 with which the distance M can be adjusted.

Thus the skirt 3 with the adjustment screws 64 can be held between the L-shaped profile 56 and the support surface 16 on the second flat plate 44 of the supporting section 5.

As the first limb 57 of the L-shaped profile 56 slides over the small plate 54, for good operation this small plate 54 is, as stated, manufactured from a material with a low coefficient of friction, for example teflon.

The table 9 is affixed movably to the supporting section 5 to make a translation movement with respect to the supporting section 5 that is transverse to the first flat plate 43 and parallel to the second flat plate 44 in order to be able to bring the skirt 3 up against the tabletop 2 or to move the skirt 3 away from the tabletop 2, for example after an initial adjustment of the alignment tool 1 for the purpose of applying glue to the skirt 3.

To this end the supporting section 5 and the table 9 have additional guiding means that consist of guides that mate together and which are complementary to one another.

More specifically, on the perpendicular profile 48 there is a guide rail 65 that mates with a guide 66 affixed to the inside 67 of the frame 53, whereby the guide 66 comprises the guide rail 65 and thus ensures a movement of the table 9 in a direction transverse to the first flat plate 43.

Moreover, on the frame 53 of the table 9 there is also a second guide rail 68 that encloses a bolt 69 on the supporting section 5, which on the one hand provides an additional guide for a movement of the table 9 in a direction transverse to the first flat plate 43, and whereby on the other hand the table 9 can be fastened with the bolt 69 in any position, within certain limits, with respect to the supporting section 5.

The bolt 69 hereby forms the releasable securing means 17 in the sense of the previous embodiment.

It is clear that an alignment tool 1 in an embodiment according to FIGS. 14 and 15 is very easy to use, whereby the alignment tool 1 is also very compact, such that it can be easily taken onto worksites and similar.

Moreover, with the vacuum pump 50, the alignment tool 1 can be fixed quickly to the first piece of material 2.

Hereby it is the intention that, after positioning the skirt 3 against the first piece of material 2, the skirt is also clamped by additional cramps 27, a preferred embodiment of which will be discussed hereinafter on the basis of FIGS. 18 and 19.

After fastening the skirt 3 with such additional cramps 27, the vacuum can be broken and the alignment tool 1 can be removed, so that the alignment tool 1 can be used to glue other pieces, for example skirts 3 to other sides of the first piece of material 2, while the cramps 27 continue to clamp the skirt 3 to the first piece of material 2 until the glue 36 has dried.

FIG. 16 shows another slightly modified embodiment of an alignment tool 1 according to the invention with vacuum pump 50, whereby the supporting section 5, just as in FIGS. 10 to 12, is constructed from two separate parts 37 and 38, that can be moved with respect to one another and locked with respect to one another.

In this embodiment the first part 37 of the supporting section 5 is formed by the first flat plate 43 with vacuum pump 50 and handle 51, whereby in this case a second guide 39 is also placed centrally on the first flat plate 43 that can mate with the second part 38 of the supporting section 5.

The second part 38 of the supporting section 5 contains the remaining parts of the alignment tool 1, more specifically the second flat plate 44, as well as the table 9 and the perpendicular profile 48 that connects the first flat plate and the second flat plate 44 (however this in an adjustable way), whereby there is still a handle 52 on the perpendicular profile 48.

The second guide 39 extends along the arm of the perpendicular profile 48 near the first flat plate 43, and enables the distance between the first flat plate 43 and the second flat plate 44 to be adjusted, for example after the first flat plate 43 has been fastened to a first piece of material 2 using the vacuum pump 50.

This can be useful, as in the example of FIGS. 10 to 12, to glue a non-mitred skirt 3 to the front of a tabletop 2, whereby the distance K can be changed in a direction HH′ parallel to the first flat plate 43, so that the skirt 3 can be brought up against the tabletop in one smooth movement without glue 36 being smeared or similar.

There are also securing means 40 on the second guide 39, in this case in the form of a screw top 40 with which the perpendicular profile 48 can be fastened in different positions with respect to the first flat plate 43 by means of a movement over or in the second guide 39.

In this way a skirt 3 on the table 9 can undergo a movement with respect to a tabletop 2 or similar in two directions HH′ and VV′, respectively in a direction HH′ parallel to the first flat plate 43 and transversely to that in a direction VV parallel to the second flat plate 44, without the skirt 3 hereby undergoing an angular movement, whereby these movements can be done in a controlled way and thus enormously simplifies the gluing.

Of course in practice many other possible embodiments are not excluded to achieve this.

Moreover the idea described here can be easily extended to directions with other orientations that are not necessarily transverse to one another or to a number of directions, for example up to three directions that are transverse to one another according to a conventional coordinate system and similar.

FIG. 17 shows another variant of an alignment tool 1 according to the invention, whereby this time the vacuum pump 50 has been omitted in order to keep the cost of the alignment tool down.

In order to be able to fasten the alignment tool 1 to the first piece of material 2, tightening means 27 can be used in the form of one or more separate cramps 27.

In this case such a separate cramp 27 is specifically constructed, with the aim of also acting as a tightening means 27 to clamp and fasten the second material 3 to the first material 2 until the applied glue 36 has hardened.

More specifically a cramp 27 in FIGS. 18 and 19 is constructed differently to the tightening means 27 of FIGS. 8 and 9, in the form of cramps 27 integrated in the alignment tool 1, which is shown more clearly on the basis of FIGS. 18 and 19.

More specifically a cramp 27 of FIGS. 18 and 19 comprises a U-shaped profile 70 formed by a central section 71 on which transversely oriented limbs are provided at each end, respectively a first limb 72 and a second limb 73.

In this case, the first limb 72 has a handle 74 in order to be able to easily handle the cramp 27.

At the free end 75 of the first limb 72, on the side of the first limb 72 that is oriented towards the central section 71, there is a small fixed support plate 76 that somewhat protrudes past the free end 75 and which extends in the line of the first limb 72.

Moreover, in order to make the free end 75 of the first limb 72 adjustable, an elongated adjustable small plate 77 is affixed to the protruding part of the fixed support plate 76 by means of a bolt 78 that extends through an elongated groove 79 in the elongated adjustable small plate 77 up to the small fixed support plate 76.

Thus the small elongated adjustable plate 77 that forms the free end 75 of the first limb 72 can be fastened in different positions on the first limb 72.

For example a small plate 77 can be rotated in a transverse position, as shown in FIG. 17, whereby the small movable plate 77 extends transversely on the first limb 72 of the cramp 27, but the adjustable plate 77 can extend just as well in the line of the first limb 72, which is shown in FIGS. 18 and 19, for example.

All intermediate orientations are of course not excluded.

Moreover it is possible to extend or shorten the first limb 72 by moving the small elongated plate 75 in the groove 76.

There is a fast-action screw 81 through the free end 80 of the second limb 73, opposite the fixed support plate 76 of the first limb 72, to form a first clamping means of the cramp 27.

By also constructing the small support plate 76 with a thickness corresponding to the thickness of the first flat plate 43 of the alignment tool 1, the free end 75 of the cramp 27 of FIGS. 18 and 19, and which free end is 75 is formed by the small adjustable plate 77, can be easily affixed over the first flat plate 43 in order to clamp this first flat plate 43 to the first piece of material 2, while the first limb 72 of the cramp 27 rests on this first piece of material 2 with the help of the small support plate 76.

This ensures an extremely stable clamping of the alignment tool 1 to the first piece of material 2, as on the one hand the cramp 27 is itself clamped to the first piece of material 2 by means of the fast-action screw 81 that mates with the small support plate 76, while the first flat plate 43 of the alignment tool 1 is also clamped separately to the first piece of material 2 through the action of the small adjustable plate 77 with respect to the clamped cramp 27, and this small plate thus forms a second clamping means of the cramp 27.

There is also a table 82 that is movable over the central section 71 of the U-shaped profile 70, whereby the table 82 can be moved between the two limbs 72 and 73, and the movement of this table 82 is guided by means of a guide 83 in the form of a guide rail 83.

In this case the table 82 does not have releasable securing means, but this is not excluded.

To adjust the position of the table 82, there is also a fast-action screw 84 through the second limb 73 that supports the table 82, and this fast-action screw 84 forms a third clamping means of the cramp 27.

On the side of the table 82 that is oriented towards the first limb 72, the table 82 is equipped with a small plate 85 that is intended to support a second piece of material 3, and which to this end, just as the small plate 54 of the alignment tool 1 of FIG. 14, is preferably manufactured from a material with a low frictional resistance, such as teflon for example.

The low frictional resistance of the small plate 85 enables a second piece of material 3 to be easily moved over the plate 85, for example in a direction parallel to the limbs 72 and 73 or in a direction transverse to the plane formed by the U-shaped profile 70, and this for example with the intention of perfectly aligning the second piece of material with the first piece of material 3 during the gluing procedure.

In an alternative even more sophisticated embodiment, to this end the small plate 85 or the entire table 82 can be affixed to the central part 71, and is also movable or adjustable in one of the aforementioned or both aforementioned directions, for example by affixing the small plate 85 to the table 82 on rollers or similar.

Finally the cramp 27 has a third fast-action screw 86 that is affixed through the central section 71, and which extends parallel to the first limb 72 at some distance from it.

This fast-action screw 86 forms a fourth clamping means so to speak.

It is clear that with a tightening means 27 as shown in FIGS. 18 and 19, a first piece of material 2 and a second piece of material 3 can be easily moved to and from one another, and can be aligned before glue 36 is applied, whereby after applying the glue 36 the two pieces of material 2 and 3 can be pressed together firmly as shown in FIG. 19.

Considered more generally, it can even be said that the tightening means 27 of FIGS. 18 and 19 are a simplified form of an alignment tool 1 according to the invention, with smaller dimensions.

Thus the alignment tools 1 according to the invention, as shown in FIGS. 1 and 14, can be considered as more robust embodiments with a support surface 16 that extends substantially in the longitudinal direction DD′ of the skirt 3 to be glued, such that very good alignment or adjustment of the skirt 3 can be realised.

On the other hand, a tightening means 27 is also an alignment tool 1 according to the invention, whereby the dimensions in the longitudinal direction DD′ of the skirt 3 are rather limited, but whereby by placing a number of such tightening means 27 at a distance from one another in the longitudinal direction DD′ of the skirt 3, a very good alignment of the skirt 3 with respect to the tabletop 2 can be obtained.

Preferably a method according to the invention is applied whereby the first alignment is done with an alignment tool 1 equipped with an aforementioned support surface 16, after which the finer adjustment or alignment can be done with tightening means 27 or alignment means 1 according to the invention with rather more limited lateral dimensions.

The present invention is by no means limited to the embodiments of an alignment tool 1 according to the invention described as an example and shown in the drawings, but an alignment tool 1 according to the invention can be realised in all kinds of variants, without departing from the scope of the invention.

1-30. (canceled)

31. An alignment tool for positioning two close-fitting pieces of material together that have to be glued together at an angle with respect to one another, wherein it has at least a supporting section with which the alignment tool can rest on a first piece of material, and a table on which the second piece of material can be affixed at the aforementioned angle with respect to the first piece of material, whereby moreover the table is affixed movably on the supporting section to make one or more translation movements with respect to the supporting section in order to be able to bring the two pieces of material together or to move them apart, without hereby undergoing a relative angular movement and whereby the supporting section is equipped with releasable securing means with which the table can be fastened in any position with respect to the supporting section.

32. The alignment tool according to claim 31, wherein it is also equipped with a tightening means with which it can be clamped to the first piece of material to be glued.

33. The alignment tool according to claim 32, wherein the supporting section is equipped with the aforementioned tightening means that are also integrated in the alignment tool.

34. The alignment tool according to claim 33, wherein the tightening means integrated in the alignment tool comprise means with which a vacuum can be created.

35. The alignment tool according to claim 34, wherein the aforementioned tightening means integrated in the alignment tool are formed by a suction pad that is equipped with a vacuum pump.

36. The alignment tool according to claim 35, wherein the vacuum pump of the suction pad is provided in a handle of the alignment tool.

37. The alignment tool according to claim 32, wherein the tightening means comprise at least one tightening screw, with which the supporting section can be clamped to the first piece of material.

38. The alignment tool according to claim 31, wherein it is equipped with a support surface against which the second piece of material affixed to the table can rest during a movement of the table, in order to set the aforementioned angle with the first piece of material on which the supporting section can rest, whereby the supporting section at least has a guide over which the table can undergo a translation in a direction parallel to the support surface against which the second piece of material can be placed on the table.

39. The alignment tool according to claim 31, characterised in that the table has releasable securing means with which the second piece of material can be held on the table.

40. The alignment tool according to claim 39, wherein the aforementioned releasable securing means is formed by a movable seat with a back parallel to the aforementioned support surface for the second piece of material, whereby spring elements are provided that exert a force on the seat in a direction towards the aforementioned support surface in order to be able to hold the second piece of material between the back and the support surface, and whereby means are provided for clamping the second piece of material to the table.

41. The alignment tool according to claim 38, wherein the supporting section consists of two parts that are movable with respect to one another, whereby the table can be moved with respect to the first part and the second part is at least provided with a guide over which the first part with the table can undergo a translation movement in a direction that is not parallel to the aforementioned support surface for the second piece of material and whereby additional releasable securing means are provided with which the first part of the supporting section can be secured in the aforementioned guide in any position.

42. The alignment tool according to claim 31, wherein the aforementioned angle at which the pieces of material have to be glued is 90°.

43. The alignment tool according to claim 31, wherein the supporting section has one or more zones, which together form a support surface in order to be able to rest against a flat side of the first piece of material.

44. The alignment tool according to claim 43, wherein the supporting section is provided with one such zone consisting of one side of a beam-shaped profile to form an aforementioned support surface on the supporting section for the first piece of material.

45. The alignment tool according to claim 44, wherein that it is provided with a perpendicular guide for the table, and this guide is perpendicular to the aforementioned support surface formed on the supporting section for the first piece of material.

46. The alignment tool according to claim 45, wherein it contains at least two parallel hooks, each consisting of two arms perpendicular to one another, whereby the hooks are connected together by means of the aforementioned beam-shaped profile that extends transversely to the hooks and which is connected to a first arm of each hook, whereby there is a rail on the other arm of each hook, and together these two rails form the aforementioned perpendicular guide for a movement of the table.

47. The alignment tool according to claim 46, wherein it is equipped with a second guide for the table and this guide is parallel to the aforementioned support surface formed on the supporting section for the first piece of material.

48. The alignment tool according to claim 46, wherein the supporting section is additionally equipped with tightening means integrated in the alignment tool for tightening the second piece of material to be glued against the first piece of material.

49. The alignment tool according to claim 46, wherein the alignment tool is equipped with limiting means to limit and guide the movement of the table up to the first piece of material.

50. The alignment tool according to claim 49, characterised in that the aforementioned limiting means are formed by one or more flat strips on the supporting section, which also form a support surface over which the second piece of material can slide during a movement of the table.

51. The alignment tool according to claim 32, wherein the tightening means are formed by a cramp that comprises a U-shaped profile, formed by a central section on which there are transversely oriented limbs at each end, respectively a first limb and a second limb.

52. The alignment tool according to claim 51, wherein the free end of the first limb is adjustable.

53. The alignment tool according to claim 52, wherein the free end of the first limb is rotatable between a position transverse to the first limb and a position in the line of the first limb.

54. The alignment tool according to claim 52, wherein the free end of the first limb is adjustable in length.

55. The alignment tool according to claim 51, wherein through the free end of the second limb there is a fast-action screw that mates with the first limb to form a first clamping means of the cramp, in order to clamp a first piece of material.

56. The alignment tool according to claim 55, wherein the cramp is equipped with a second clamping means for additional clamping to the clamped first piece of material.

57. The alignment tool according to claim 51, wherein a table is provided in a movable way over the central section of the U-shaped profile, whereby the table can be moved between the two limbs.

58. The alignment tool according to claim 57, wherein in order to adjust the position of the table on the central section, there is also a fast-action screw through the second limb that supports the table, to form a third clamping means.

59. The alignment tool according to claim 57 wherein, on the side of the table that is oriented towards the first limb, the table has a small teflon plate that is intended to movably support a second d piece of material.

60. The alignment tool according to claim 51, wherein the cramp is equipped with a fast-action screw, to form a fourth clamping means, and this fast-action screw is affixed through the central section and extends parallel to the first limb at some distance from it.
